(19) United States
(12) Patent Application Publication
(10) Pub. No.: US 2016/0081302 A1
(43) Pub. Date: Mar. 24, 2016

(54) DOG SCENT-TRAINING SYSTEM

(71) Applicant: Randall G. Hare, Flowood, MS (US)

(72) Inventors: Randall G. Hare, Flowood, MS (US); Chester F. Robards, JR., Flora, MS (US)

(73) Assignee: Randall G. Hare, Flowood, MS (US)

(21) Appl. No.: 14/492,167

(22) Filed: Sep. 22, 2014

(51) Int. Cl. A01K 15/02

(52) U.S. Cl. CPC A01K 15/02

(57) ABSTRACT

A dog scent-training system is provided with a housing fabricated from a class of materials which may include a scent absorbing material. A container is provided for holding a scent-emitting material. The container is positionable inside the housing. The container is fabricated of scent-impervious material and has passages for passing scent therethrough to the ambient atmosphere.

### FIELD OF THE INVENTION

This invention generally relates to the art of scent-training devices to assist in training a dog to locate specific target items.

### BACKGROUND OF THE INVENTION

Dogs have an acute sense of smell and have been used to perform various scent-based detection work. For instance, dogs have been used for narcotic and explosive detection by police and federal authorities, as well as incendiary device detection for bomb threats. Dogs have been used in search and rescue missions for finding missing or injured persons. Dogs further have been used in accelerant detection in arson investigations, as well as many other scent-based detection work.

While prior dog scent-training devices may have been proven effective, they have not been efficient in allowing dog training where the devices must be used over and over again in repeated training sessions. This invention is directed to solving the needs in scent-training of dogs in a very efficient and economical system.

### SUMMARY OF THE INVENTION

An object, therefore, of the invention is to provide a new and improved dog scent-training system or device of the character described.

In the exemplary embodiment of the invention, a housing is provided and is fabricated from a class of materials which may include a scent absorbing material. A container is provided for holding a scent-emitting material. The container is positionable inside the housing. The container is fabricated of scent-impervious material and has passages for, passing scent therethrough to the ambient atmosphere. Therefore, the container can be removed from the housing for repeated and varied training exercises, while the container can be cleaned between exercises for holding successive target materials.

According to one aspect of the invention, the housing has an access opening for positioning the container therethrough into the housing. In the exemplary embodiment of the invention, the access opening is located in one side of the housing, such as at the front the housing. The housing has a second opening for depositing therethrough a reward item for retrieving by the dog. In the exemplary embodiment of the invention, the second opening comprises a drop opening in the top of the housing for dropping the reward item therethrough whereby the reward item will fall into the housing toward the container.

According, to another aspect of the invention, an interior partition wail inside the housing defines a lower scent chamber or reward chamber within which the container is located to aid in confining the scent therewithin. The interior partition wall has a passage aligned with the drop opening in the top of the housing for the reward item to drop through the passage into the lower scent chamber. As disclosed herein, a guide tube extends between and is aligned with the drop opening and the passage to guide the reward item as it falls into the scent chamber.

According to still another aspect of the invention, complementary interengaging attachment means are provided between the container and the interior of the housing for readily mounting and removing the container inside the housing without the use of tools.

Although other materials are contemplated by the invention, in the preferred embodiment of the invention, the housing is fabricated of wood in the shape of a box, and the container is fabricated of scent-impervious PVC material.

Other objects, features and advantages of the invention will be apparent from the following detailed description taken in connection with the accompanying drawings.

### BRIEF DESCRIPTION OF THE DRAWINGS

The features of this invention which are believed to be novel are set forth with particularity in the appended claims. The invention, together with its objects and the advantages thereof, may be best understood by reference to the following description taken in conjunction with the accompanying drawings, in which like reference numerals identify like elements in the figures and in which:

FIG. 1 is a front perspective view of the dog scent-training device or system of the invention;

FIG. 2 is a front elevational view of the device, with the front wall of the housing removed to facilitate an illustration of the interior of the housing;

FIG. 3 is a top plan view of the device;

FIG. 4 is a vertical section taken generally along line 4-4 in FIG. 2;

FIG. 5 is a perspective view of the container for holding a scent-emitting material, looking at the rear of the container;

FIG. 6 is a front perspective view of the bowl-part of the container;

FIG. 7 is a section taken generally along line 7-7 in FIG. 5;

FIG. 8 is a section through the bowl-part of the container; and

FIG. 9 is an exploded perspective view of the container in relation to the housing.

### DETAILED DESCRIPTION OF THE PREFERRED EMBODIMENT

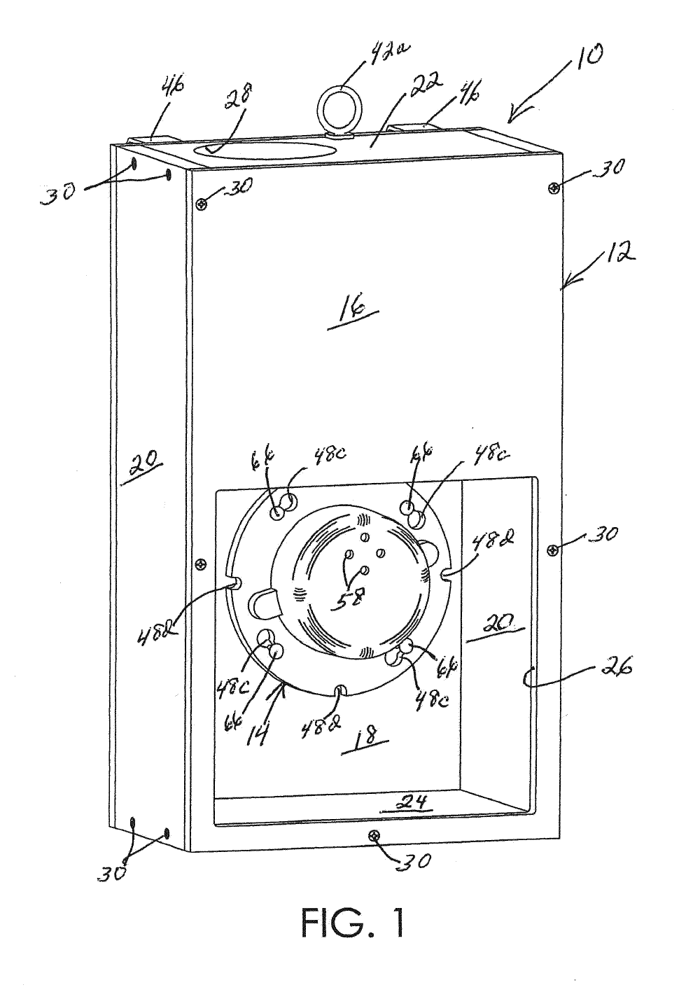

Referring to the drawings in greater detail, and first to FIGS. 1-4, the invention is incorporated in a dog scent-training device or system, generally designated 10. The device includes a housing, generally designated 12, and a closed container, generally designated 14. The container is provided for holding a scent-emitting material, and the container is positionable inside the housing as seen in FIGS. 1, 2 and 4.

More particularly, housing 12 is fabricated from a class of materials which may include a scent absorbing material such as wood, thick corrugated paper or cardboard or any variety of materials which are relatively inexpensive, easy to work with but which, typically, will absorb scents. Housing 12 includes a front wall 16, a rear wall 18, opposite vertical side walls 20, a top wall 22 and a bottom wall 24, all of which combine to form a box-like shape. As best seen in FIG. 1, front wall 16 has an access opening 26 into which container 14 can be inserted and mounted against the inside of rear wall 18. Top wall 22 of the housing includes a drop opening 28, for purposes to be described hereinafter. All of the walls are secured together in the shape of the box by appropriate fasteners, such as screws 30. Other securing means are contemplated, such as all of the walls being, held together in the shape shown by appropriate epoxy material, or the housing could be molded or otherwise fabricated.

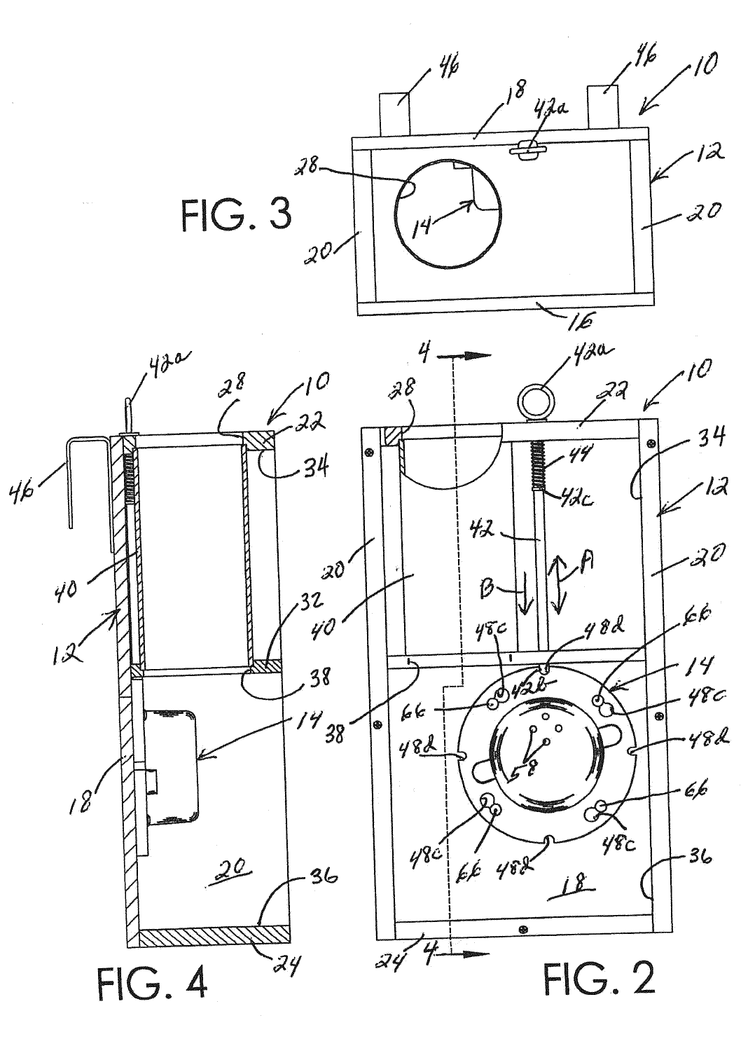

Referring to FIGS. 2 and 4, an interior partition wall 32 divides the interior of housing 12 into an upper chamber 34 and a lower chamber 36. The lower chamber can be called the “scent chamber” or the “reward chamber” because it performs dual functions. First, it can be seen that the chamber is not very much bigger than container 14 and, thereby, confines the scent as much as possible to the vicinity around the container. Of course, the scent will migrate somewhat out of the housing through access opening 26 (FIG. 1) whereby the minimal scent which migrates will attract the dog to the container. Secondly, lower chamber 36 defines a reward chamber into which a reward item can be dropped from the top of the device, as described below.

Still referring to FIGS. 2 and 4, partition wall 32 is provided with a passage 38 which is aligned with drop opening 28 in the top wall of the housing. A guide tube 40 is mounted within the housing and is aligned with and extends between drop opening 28 and passage 38 so that a reward item can be deposited through the drop opening whereby the item will drop down into reward chamber 36 in the vicinity of container 14. In the preferred embodiment, guide tube 40 is cylindrical and, therefore, drop opening 28 and passage 38 are circular.

Still referring to FIG. 2, a detent rod 42 is appropriately mounted in top wall 22 and partition wall 32 for reciprocal movement in the direction of double-headed arrow “A”. A pull ring 42a is provided at the top of the rod above top wall 22 of the housing for grasping by a trainer to pull up on the rod. The bottom of the rod forms a detent tip 42b for locking container 14 in the housing as described hereinafter. A coil spring 44 surrounds detent rod 42 within the housing and is compressed between the underside of top wall 22 of the housing and a fixed peripheral flange 42c formed about the rod. Therefore, coil spring 44 constantly biases the detent rod downwardly in the direction of arrow “B”. Therefore, the trainer pulls detent tip 42b away from the container by pulling on ring 42a, and the coil spring automatically snaps the rod downwardly and detent tip 42b against the container when the trainer releases the ring.

FIGS. 3 and 4 show a pair of mounting hooks 46 for mounting the device on an appropriate supporting structure. For instance, a whole series of the devices can be mounted along a railing to present the dog with a row of identical boxes with only a limited number containing a target.

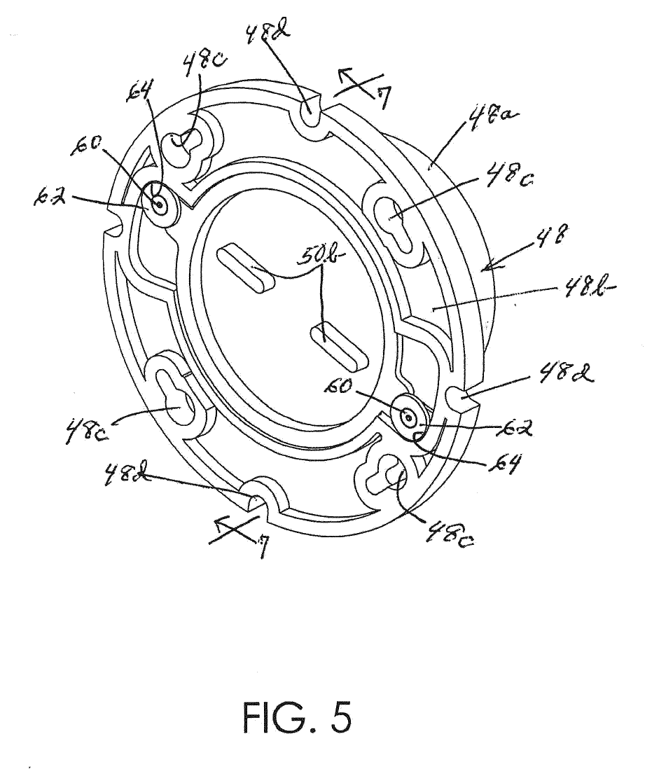

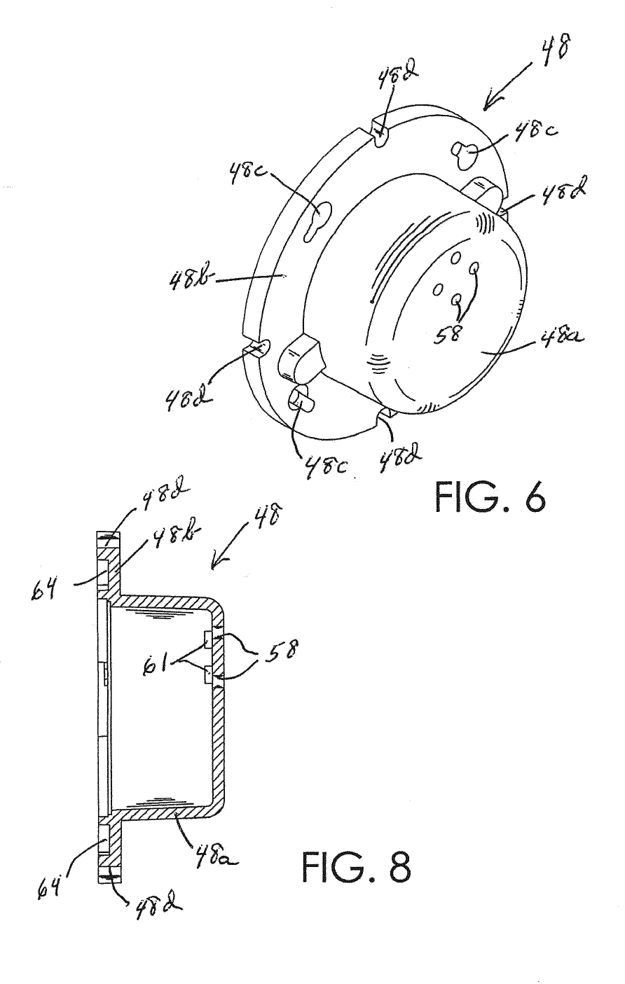

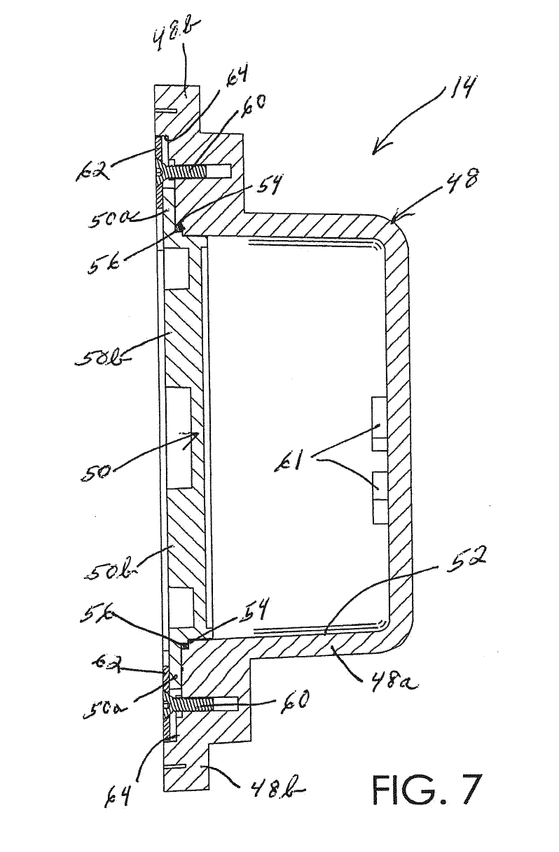

Referring to FIGS. 5-8, container 14 is made of two primary components, namely, a bowl-shaped part, generally designated 48, and a lid or closure part, generally designated 50. When the two parts are assembled as shown in FIGS. 5 and 7, they form an interior cavity 52 (FIG. 7). The cavity can contain a wide variety of target items (“targets”), such as narcotics, drugs, incendiary devices, accelerants or a variety of fabric items for locating missing persons. Many other targets are contemplated. The bowl-shaped part 48 includes a bowl portion 48a which forms one side of cavity 52 and an outwardly projecting, peripheral flange portion 48b. A plurality of keyhole-shaped holes 48c are formed through flange 48b as best seen in FIGS. 5 and 6. A plurality of detent slots 48d are formed in the outer edge of flange 48b. As disclosed, there are four keyholes 48c with four detent slots 48d spaced therebetween. Of course, other numbers of keyholes and detent slots are contemplated. The four detent slots provide for easily positioning container 14 within the housing in any one of four different positions.

Lid 50 is sized and shaped for fitting into the outer edge of cavity 52 as seen in FIGS. 5 and 7. The lid is formed with an outwardly projecting, peripheral flange 50a which overhangs a ledge 54 formed about the outer edge of cavity 52. If needed, a seal ring 56 is sandwiched between flange 50a and ledge 54 to seal cavity 52 and not allow the scent to migrate therefrom toward the housing to which container 14 is mounted. The scent passes out of the front of container 14 through a plurality of small holes 58 shown best in FIGS. 1 and 6. A plurality of inwardly projecting ribs 61 are formed inside bowl 48 adjacent holes 58 to prevent a target from blocking the holes and preventing the scent from passing therethrough.

Lid 50 is held in position onto bowl 48 by a pair of screws 60 (FIG. 7) and a complementary pair of washers 62 through which the screws extend, As best seen in FIG. 5, washers 62 are recessed within a pair of circular recesses 64 formed in the back faces of flange 48b of bowl 48. When screws 60 are tightened, washers 62 are drawn against flange 50a to draw lid 50 against seal ring 56 to tightly seal cavity 52 of bowl 48. A pair of elongated bosses 50b are integrally molded with the outer surface of lid 50 for grasping by a trainer to manipulate the lid.

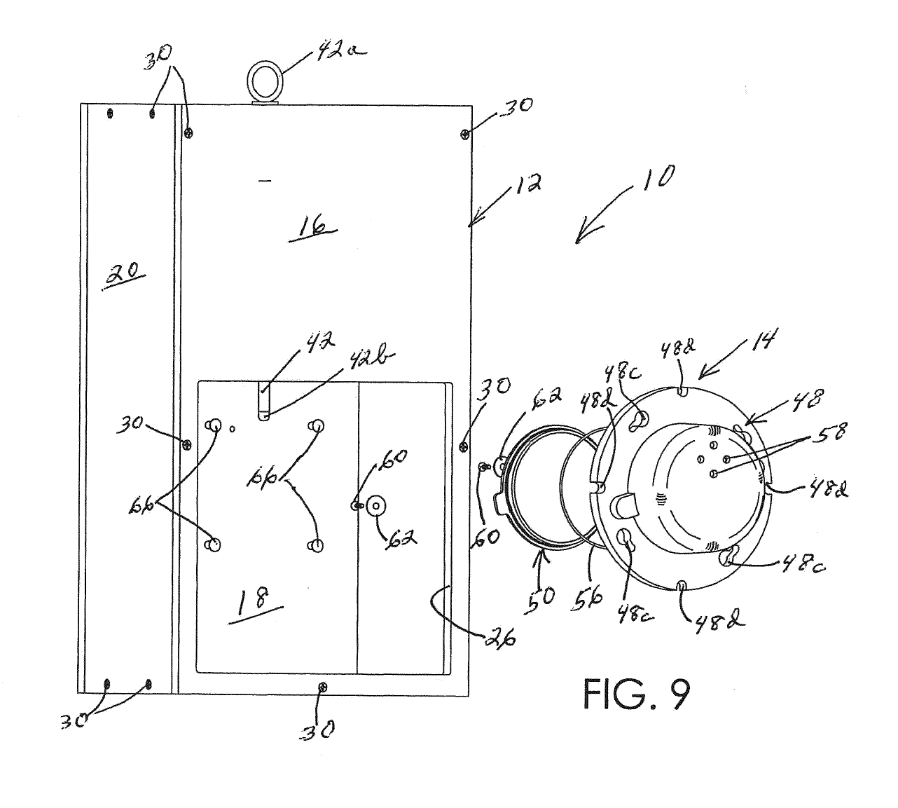

Referring to FIG. 9 in conjunction with FIGS. 1 and 2, four stand-off, headed mounting studs 66 are inserted into rear wall 18 of housing 12 so that the heads of the stand-off studs are spaced forwardly of the inside surface of the rear wall. The stand-off studs are located and properly spaced for alignment with keyholes 48c in bowl 48 of container 14. Container 14 is mounted within the housing by aligning the enlarged portions of keyholes 48c with stand-off studs 60, while the trainer pulls up on detent rod 42 so that the backside of the container abuts against the inside surface of rear wall 18. At that point, the trainer can release the detect rod, whereupon coil spring 44 will bias the rod downwardly. The container then is rotated so that the shank of stand-off studs 66 enter the narrow portions of the keyholes so that the container cannot be pulled outwardly away from the rear wall of the housing. As the trainer releases detent rod 42, the detent tip 42b of the rod snaps into one of the detent slots 42d of the container, whereby the container no longer can be rotated and the container is locked within the housing.

It can be seen in FIGS. 1 and 2 that scent holes 58 in bowl 48 of container 14 are located in one quadrant of the bowl, rather than being centrally located. This allows the scent holes to be spaced at different distances from a reward item, depending on the particular angle of rotation (defined by the detents) that the container is mounted inside the housing.

In use, a trainer can mount any number of devices 10 in close or spaced proximity. For instance, in training sessions, hooks 46 can be used to mount a plurality of the devices along a railing whereby a trainer can be positioned behind the railing, away from the dog and the trainer can drop a reward item down through guide tube 40 into reward chamber 36. The dog can be led along the series of devices or boxes while the dog searches for a designated scent. Any number of the devices can be mounted, with the container of only one of the devices or boxes containing a scent-emitting material or “target”. In other words, only one of the devices is “loaded”. Once the dog is successful in identifying the loaded box, the trainer can drop a reward item into drop opening 28 at the top of the housing, and the reward item will fall through guide tube 40 and into chamber 36 immediately adjacent the container which holds the “target”. The reward item can be any variety of configurations, such as a ball on a tether with which the dog loves to play, or even an item of food which the dog can eat. By using the different interior chambers and the drop opening and guide tube, the trainer remains relatively removed from the target so that the dog learns to rely on his sense of smell and ignore his other senses.

After training sessions are over, container 14 can be very easily removed from the housing without any tools whatsoever simply by lifting up on the detent rod, rotating container 14 slightly as stand-off studs move in the keyholes. The container then can be taken to a location remote from housing 10 and washed or cleaned to remove any remaining scent since the container is fabricated of scent-impervious material. This material can include PVC, metal, glass, glazed pottery or any other material which is highly resistant to penetration and retention of odors and is easily cleanable to remove any trace odors.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

1. A dog scent-training system, comprising:
a housing fabricated from a class of materials which may include a scent absorbing material; and
a container for holding a scent-emitting material, the container being positionable inside the housing, and the container being fabricated of scent-impervious material and having passages for passing scent therethrough to the ambient atmosphere.

2. The dog scent-training system of claim 1 wherein said housing has an opening for positioning the container therethrough into the housing.

3. The dog scent-training system of claim 2 wherein said opening is located in the side of the housing.

4. The dog scent-training system of claim 1 wherein said housing has an opening for depositing therethrough a reward item for retrieving by the dog.

5. The dog scent-training system of claim 4 wherein said opening is located in the top of the housing.

6. The dog scent-training system of claim 1 wherein said housing has an access opening in the side thereof for positioning the container into the housing, along with a drop opening in the top of the housing for depositing therethrough a reward item for retrieving by the dog.

7. The dog scent-training system of claim 6 wherein said drop opening is in a top wall of the housing, and including an interior partition wail defining a lower scent chamber within which the container is located to aid in confining the scent therewithin, the interior partition wall having a passage aligned with the drop opening for the reward item to drop through the passage into the lower scent chamber.

8. The dog scent-training system of claim 7, including a guide tube extending between and aligned with the drop opening and the passage.

9. The dog scent-training system of claim 1, including complementary interengaging attachment means between the container and the interior of the housing for readily mounting the container inside the housing without the use of tools.

10. The dog scent-training system of claim 1 wherein said container is fabricated of PVC material.

11. The dog scent-training system of claim 10 wherein said housing is fabricated of wood in the shape of a box.

12. A dog scent-training system, comprising:
a housing fabricated from a class of materials which may include a scent absorbing material; and
a container for holding a scent-emitting material, the container being releasably attached to the housing, and the container being fabricated of scent-impervious material and having passages for passing scent therethrough to the ambient atmosphere.

13. The dog scent-training system of claim 12, including complementary interengaging attachment means between the container and the housing for readily mounting the container on the housing without the use of tools.

14. The dog scent-training system of claim 12 wherein said housing is fabricated of wood in the shape of a box.

15. The dog scent-training system of claim 12 wherein said container is fabricated of PVC material.

16. The dog scent-training system of claim 12 wherein said container includes a bowl-shaped part for holding the scent-emitting material and a lid for closing the bowl.

17. A dog scent-training system, comprising:
a housing fabricated from a class of materials which may include a scent absorbing material;
a container for holding a scent-emitting material, the container being positionable inside the housing, and the container being fabricated of scent-impervious material and having passages for passing scent therethrough to the ambient atmosphere; and
wherein said housing includes a first opening for positioning the container therethrough into the housing, and a second opening for depositing therethrough a reward item for retrieving by the dog.

18. The dog scent-training system of claim 17 wherein said first opening is located in the side of the housing.

19. The dog scent-training system of claim 17 wherein said second opening is located in the top of the housing.

20. The dog scent-training system of claim 19 wherein said second opening is located so that, the reward item is deposited near the container.
